(19) United States
(12) Patent Application Publication
(10) Pub. No.: US 2006/0238321 A1
(43) Pub. Date: Oct. 26, 2006

(54) Networked vehicle system and vehicle having the same

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/408,409

(22) Filed: Apr. 21, 2006

(30) Foreign Application Priority Data
Apr. 22, 2005 (CN) 200510034362.3

(51) Int. Cl. B60Q 1/00; G01M 17/00; G06F 19/00

(52) U.S. Cl. 340/438; 701/29; 701/114

(57) ABSTRACT

A networked vehicle system includes an information center, a wireless communication system, a safety system, an identification recognition and theft protection system, and a multimedia entertainment system. The information center includes a host computer system configured for communicating with a wireless external network and a signal emitting system configured for transmitting/broadcasting signals according to commands received from the host computer system. The wireless communication system, the safety system, the identification recognition and theft protection system, and the multimedia entertainment system are respectively connected to the host computer system.

### CROSS-REFERENCE TO RELATED APPLICATION

This application is related to a copending U.S. patent application Ser. No. 11/306492, filed on Dec. 29, 2005, entitled “VEHICLE SAFETY SYSTEM AND VEHICLE HAVING THE SAME”, and having the same assignee as this application. The disclosure of the above-identified application is incorporated herein by reference.

### 1. TECHNICAL FIELD

The present invention relates to vehicle propulsion, safety, protection, entertainment, communication and information systems and the like, and particularly to a networked vehicle system involving a host computer system.

### 2. BACKGROUND

In many modern societies, vehicles for private domestic or commercial use are becoming more and more popular as the transportation of choice for people and goods. However, problems such as traffic accidents and pollution are increasing along with the booming development of automobiles. These problems constitute direct and long-term threats to people's well-being.

In particular, many people are becoming more safety-conscious due to the frequent occurrence of traffic accidents which result in loss of lives and property. In general, traffic accidents involve collision of a vehicle, which in turn is often the result of a traffic violation. In addition to human factors such as drink driving or speeding, other main reasons for traffic accidents are generally associated with more objective factors including poor visibility and blind spots in the normal field of vision of a driver.

Furthermore, there are many situations where a traffic accident has occurred and no reliable evidence is available as to what happened. Drivers or passengers may be too shocked to reliably recall events of and events leading up to a traffic accident, particularly an accident involving vehicle collision. Indeed, some traffic accidents may not have occurred at all, but for the fact that the driver and/or passengers were too panic-stricken during events leading up to the accident to be able to take effective preventive measures. Also, there are many situations where a crime involving a vehicle has occurred, and no reliable evidence is available to trace the offender. Such incidents usually involve theft of parts of the vehicle or even the vehicle itself, or vandalism of the vehicle.

Moreover, with the booming improvement of living standards in developing countries, traditional vehicles cannot necessarily provide satisfactory amenity to meet the high expectations of drivers and passengers alike. For example, a traditional domestic automobile generally only provides in-transit entertainment such as a stereo audio system. In addition, a traditional domestic automobile does not provide communication or other automated facilities that are in general enjoyed by drivers and passengers only when they are at home or at work.

What is needed, therefore, is a networked vehicle system for use in a vehicle which is able to decrease the risk of traffic accidents occurring, automatically send signals for help in the event of a traffic accident, and provide various entertainment and communication facilities. What is also needed is a vehicle having the networked vehicle system.

### SUMMARY

A networked vehicle system for use in a vehicle includes an information center, a wireless communication system, a safety system, an identification recognition and theft protection system, and a multimedia entertainment system. The information center includes a host computer system configured for communicating with a wireless external network and a signal emitting system configured for transmitting/broadcasting signals according to commands received from the host computer system. The wireless communication system communicates with the host computer system, and is configured for effectuating data/information communication between the information center and the wireless external network. The safety system includes a plurality of image pick-up systems each configured for being mounted to the vehicle, the image pick-up systems each being connected to the host computer system and being configured for recording video images of inside and/or outside statuses of the vehicle. The identification recognition and theft protection system includes a signal amplifier comparator and a plurality of recognition sensors, the recognition sensors each being configured for transmitting recognition signal captured by the recognition sensors to the signal amplifier comparator, the signal amplifier comparator being connected to the host computer system, and being configured to compare the recognition signals with pre-stored data and transmit a comparison result to the host computer system. The multimedia entertainment system includes a videoconference system, one or more video/audio input devices, and one or more video/audio output devices, each of the video/audio input and output devices being connected with the host computer system.

A vehicle includes a vehicle body and the above-described networked vehicle system provided in the vehicle body.

Other advantages and novel features of various embodiments will become more apparent from the following detailed description when taken in conjunction with the accompanying drawings.

### BRIEF DESCRIPTION OF THE DRAWINGS

Many aspects with regard to the networked vehicle system and associated vehicle can be better understood by reference to the following drawings. The components in the drawings are not necessarily to scale, the emphasis instead being placed upon clearly illustrating the principles relating to the present networked vehicle system and associated vehicle. Moreover, in the drawings, like reference numerals designate corresponding parts throughout the several views.

FIG. 1 is a schematic, side plan view of an exemplary passenger vehicle having a networked vehicle system according to an exemplary embodiment of the present invention, the networked vehicle system including a plurality of various systems mounted on the vehicle.

FIG. 2 is a block diagram of a networked vehicle system in accordance with an exemplary embodiment of the present invention.

FIG. 3 is essentially a schematic, top view of the vehicle of FIG. 1, but not showing a roof of the vehicle, and showing a safety system mounted in the vehicle.

### DETAILED DESCRIPTION OF THE EMBODIMENTS

Embodiments of the present invention will now be described in detail below including with reference to the drawings.

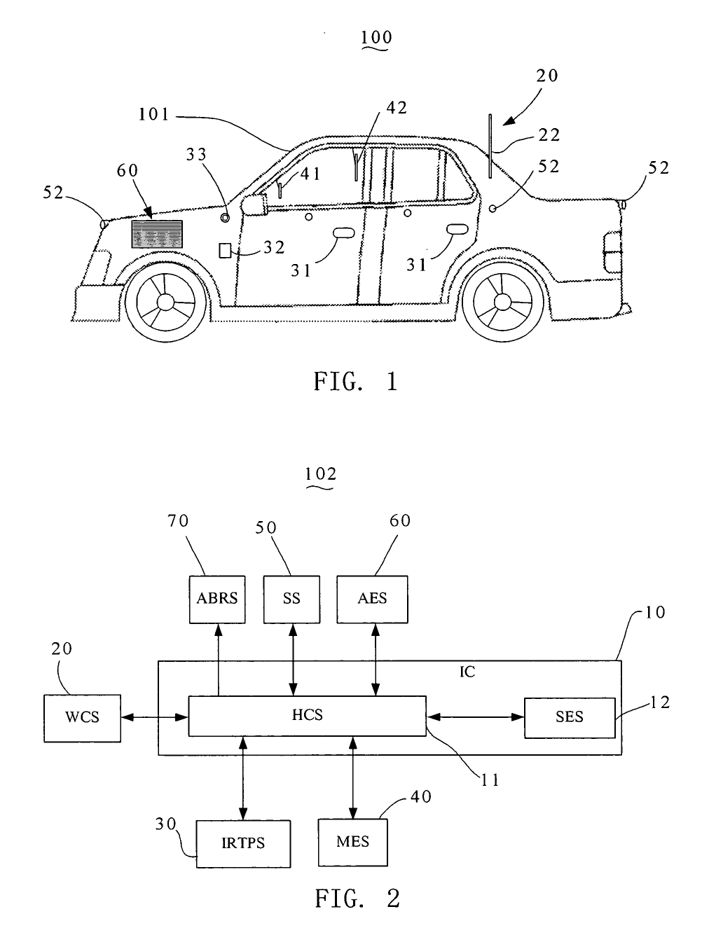

FIGS. 1 and 2 illustrate an exemplary passenger vehicle and a networked vehicle system used in the vehicle. The passenger vehicle 100 has a main vehicle body 101, and a networked vehicle system 102 mounted on and in the vehicle body 101. The networked vehicle system 102 mainly includes an information center (hereinafter, IC) 10, a wireless communication system (hereinafter, WCS) 20, an identification recognition and theft protection system (hereinafter, IRTPS) 30, a multimedia entertainment system (hereinafter, MES) 40, a safety system 50 (hereinafter, SS), and an automatic engine system (hereinafter, AES) 60. The IC 10 mainly includes a host computer system (hereinafter, HCS) 11, and a signal emitting system (hereinafter, SES) 12. The WCS, IRTPS, MES, SS, and AES 20, 30, 40, 50, 60 are each connected to the HCS 11 for attaining data/information communication therebetween.

The IC 10 is advantageously positioned at or near an instrument panel of the vehicle 100, for facilitating a driver of the vehicle 100 to control and monitor the IC 10. The HCS 11 mainly includes a microprocessor and a plurality of USB (Universal Serial Bus) ports. The HCS 11 is able to communicate with an external wireless network. The SES 12 is connected to the HCS 11, and is configured for transmitting/broadcasting signals according to corresponding commands received from the HCS 11.

The WCS 20 may be disposed on the vehicle body 101, for communicating with the HCS 11. Alternatively, the WCS 20 can be in a form of a mobile phone. The WCS 20 advantageously includes a blue tooth (BT) module, an ultra wide band (UWB) module, and a global positioning system (GPS). The GPS and the BT and UWB modules cooperatively form a hybrid positioning system, thereby increasing a broadcast area and broadcast definition of the WCS 20.

The BT module advantageously has a broadcast speed in the range from about 700 Kbps (kilobytes per second) to about 1000 Mbps (Megabytes per second). The BT module generally has various functional units/sections such as, for example, a radio communication unit, an antenna section for carrying out transmission/reception of data, a base band control section for giving a hopping frequency pattern to the radio communication unit, and an interface section for carrying out input/output of data to/from the HCS 11. The antenna section generally includes an antenna 22. Advantageously, the antenna 22 extends out of the vehicle body 101 during operation of the WCS 20, as shown in FIG. 1. The base band control section carries out modulation and demodulation processing of frequency hopping, processing of signals received from the radio communication unit for conversion into data in a predetermined format that can be read by the HCS 11, and transmission of the data in the predetermined format to the interface section. The base band control section also carries out processing of data in the predetermined format received from the interface section, for conversion of such data into signals for transmission to the radio communication unit. The radio communication unit has a receiving section for carrying out processing for receiving incoming signals from the antenna section, a transmitting section for carrying out processing for transmitting outgoing signals from the antenna section, a switch section for switching between transmission of outgoing signals from the transmitting section via the antenna section and transmission of incoming signals from the antenna section to the receiving section, and a hopping synthesizer section for carrying out spectrum spreading based on frequency hopping with respect to the signals in the receiving section and the transmitting section.

The UWB module advantageously has a broadcast speed in the range from about 100 to about 500 Mbps, and more advantageously in the range from about 100 to about 1000 Mbps. The UWB module generally has various functional sections such as, for example, a UWB antenna section for carrying out transmission/reception of signals, a UWB receiving section for receiving signals from the UWB antenna section, and a UWB transmitting section for transmitting signals from the UWB antenna section. The antenna 22 also services the UWB antenna section. That is, the antenna 22 serves as a common antenna for both the antenna section of the BT module and the UWB antenna section of the UWB module.

The BT and UWB modules are each bridged to the HCS 11, thereby effectuating data/information communication between the HCS 11 and the external wireless network.

The IRTPS 30 includes a signal amplifier comparator, and a plurality of recognition sensors. Each recognition sensor is capable of transmitting captured recognition signals to the signal amplifier comparator. The signal amplifier comparator is configured for amplifying and comparing recognition signals received from recognition sensors with predetermined signals. The comparison resultant is transmitted to the HCS 11 connected with the signal amplifier comparator. The recognition sensors include a number of fingerprint sensors 31, image sensors 32, and voice sensors 33, as shown in FIG. 1. The recognition sensors 31, 32, 33 may be located uniformly or non-uniformly on an exterior and/or an interior of the vehicle body 101, for example, on external and/or internal surfaces of doorframes of the vehicle, and/or on surfaces of outer and/or inner door handles of the vehicle 100.

The recognition sensors 31, 32, 33 are configured to provide input to the system 30, in order to recognize the identy of an authorized user of the vehicle 100, and to recognize anyone who is not authorized to enter or be with the vehicle 100. When a person enters or is with the vehicle 100, any one or more of the recognition sensors 31, 32, 33 can detect the person and input corresponding signals to the system 30. Typically, one of the fingerprint sensors 31 and one or more of the image sensors 32 inputs signals such as fingerprint and image signals. The signals are compared by the signal amplifier comparator with user information pre-stored in the system 30. If the signals match the user information, the system 30 identifies the person as an authorized user and permits the person to enter the vehicle. Oppositely, if the signals do not match the user information, an abnormal data signal is transmitted to the HCS 11. The HCS 11 immediately triggers an alarm, and the SES 12 transmits alarm information to a predetermined receiver. The alarm may be an audible alarm. The predetermined receiver may, for e.g., be the owner of the vehicle or a security or police office. The alarm information may include fingerprint/video/audio information captured by the recognition sensors 31, 32, 33 in real time. Thus the risk of theft of parts of the vehicle 100 or the vehicle 100 itself, and the risk of vandalism, can be decreased. Furthermore, the IRTPS 30 can be configured to perform similar functions to those described above in the event that an unauthorized person breaks into the vehicle 100. Therefore, even if the unauthorized person steals a part of the vehicle 100 or the vehicle 100 itself or vandalizes the vehicle 100, the predetermined receiver can obtain information that can help identify the offender and record the occurrence of the offence.

The MES 40 includes a videoconference system, video/audio input devices, and video/audio output devices, each of which is connected with the HCS 11. The videoconference system includes a plurality of functional modules, such as, for e.g., a conference management module, a coprocessor module, video/audio management modules, and a multipoint control module (also referred to as video bridge or conference server). The system 40 can share the communication function of the MES 30, thereby effectuating data/information communication with other external videoconference systems.

Each video input device can, for e.g., be a camera. Each audio input device can, for e.g., be a microphone. Each video output device is preferably and advantageously a high definition display; for example, a high-definition plasma display, a high-definition liquid crystal display, or a high-definition field emission display. The video output devices can be disposed in the driver's compartment and passenger compartment. For example, a front display device 41 can be provided in the driver's compartment, and a number of passenger display devices 42 can be provided in the passenger compartment. If desired, common video information can be shared by the driver and passengers. Alternatively, the driver and each of the passengers may receive independent video information at the respective front display device 41 and passenger display devices 42, according to need. Each audio output device is preferably and advantageously a high-definition or high fidelity acoustic device, and is preferably disposed at a top region of the driver's compartment or passenger compartment. Thus, the MES 40 can provide multiple functions for the driver and/or the passengers. Such functions include, for e.g., a videoconference among a plurality of attendees in real time, and in situ enjoyment of entertainment obtained from the networked vehicle system 102.

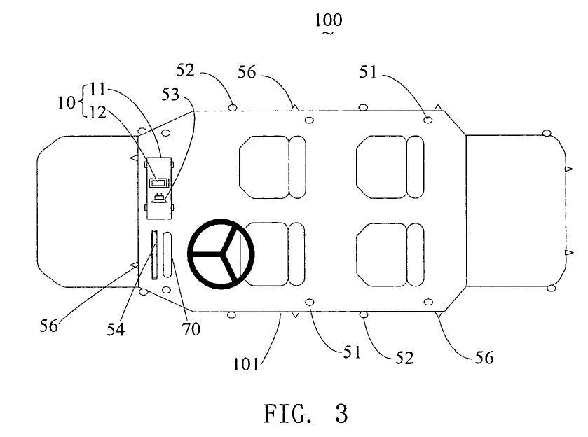

Referring to FIG. 3, the SS 50 includes a plurality of internal image pick-up systems 51 mounted inside the vehicle 100, a plurality of external image pick-up systems 52 mounted at an outside of the vehicle 100, a display monitor 54, and an air bag restraint system (hereinafter, ABRS) 70.

The internal and external image pick-up systems 51 and 52 each include an autofocus zoom lens system. The autofocus zoom lens system includes an optical module, a sensor, and a driving module. The optical module includes a plurality of aspheric lenses and an infrared filter. More preferably, at least one of the aspheric lenses has anti-reflection coatings on both of main surfaces thereof. The sensor can be a CMOS (complementary metal-oxide semiconductor) sensor, or a CCD (charged coupled device) sensor. The driving module includes an actuator and an extendable barrel. The actuator may be selected from the group consisting of a stepper motor, a voice coil motor, and a microelectromechanical motor.

The external image pick-up systems 52 can be arranged at a front side, a back side, and two lateral sides of the vehicle 100, for monitoring the environmental conditions (e.g. a traffic status) around the vehicle 100 via the autofocus zoom lens systems. The internal image pick-up systems 51 can be arranged spatially so as to correspond to seats of the vehicle 100, for monitoring the statuses of the driver and passengers in the vehicle 100. Video images captured by the image pick-up systems 51 and 52 can be transferred to the HCS 11. The driver can select to view a desired video image to be displayed on the display monitor 54. Alternatively, more than one monitoring video image can be displayed on the display 54 monitor together at the same time. Furthermore, the video output device of the MES 40 could be used as a monitor display in the SS 50.

The image pick-up systems are each connected to the HCS 11. As such, the HCS 11 can save the video images received from the image pick-up systems into a storage device, and can send the video images to intended receivers in the form of RF (radio frequency) signals via the WCS 20. In one example, the HCS 11 may be preset to send the video images to the owner of the vehicle 100 even when the vehicle 100 has been stolen. The video images can be provided to the police to assist them in finding and prosecuting the offender. In another example, when a traffic accident happens, the ABRS 70 can send a control instruction to a gas inflator (not shown) to instantly inflate an air bag (not shown). At the same time, the HCS 11 receives a corresponding instruction, and controls the SES 12 to send RF signals for help and video images to predetermined receivers such as a hospital, a police station, a fire station, etc. Even if the driver and passengers are too seriously injured to help themselves or seek help for themselves, the predetermined receivers can still obtain detailed information about the accident in real time. Such information may include the states of the injured driver and passengers, the status of the vehicle 100, and the situation at the accident scene. The predetermined receivers can initiate appropriate measures without delay. Thus loss of life can be prevented, and injury and property damage can be minimized.

Furthermore, the SS 50 includes a number of detectors 56 connected to the HCS 11, and an annunciator 53. The detectors 56 can be arranged at the front side, the back side, and the two lateral sides of the vehicle 100. The detectors 56 are configured for detecting distances between the vehicle 100 and ambient vehicles or objects, and for sending corresponding distance data to the HCS 11. When a distance detected by any of the detectors 56 is less than a predetermined safe distance, the HCS 11 can send out an audible alert via the annunciator 53 to appropriately prompt the driver. The annunciator 53 can provide prompts in various forms, for example, human voice prompts. Therefore, even if the driver overlooks corresponding video images displayed on the display monitor 54, the annunciator 53 can still prompt the driver with audible alerts. As a result, the risk of a traffic accident occurring can be further minimized.

The AES 60 is generally secured to a part of the vehicle body 101 such as a front frame thereof. The AES 60 advantageously includes an engine control device and a power system. The engine control device is connected with the HCS 11 for accepting control commands therefrom. The HCS 11 can be preset according to any one of a range of preferred driving modes; each of which may be suitable according to particular driving conditions that may prevail. For example, one driving mode may be directed to economizing on power from the power source, and another driving mode may be directed to protecting the vehicle from excess or undue operation. Further, the HCS 11 can be configured to provide a desired driving approach according to parameters written thereinto by the driver. Then the engine control device controls output power parameters of the power system according to corresponding control commands sent from the HCS 11. At the same time, the output power parameters can be fed back to the HCS 11 so as to provide a reference or basis for configuring a next driving approach. Thereby, the AES 60 and the HCS 11 can achieve a desired type of automatic control for assisting the driving of the vehicle.

The output power parameters mainly include driving speed, driving horsepower, driveshaft rotational speed, driveshaft torque, transmission settings, cruise control parameters, and so on. The power system mainly includes a hybrid engine device, a variable transmission device, a power output device, and a power distribution device. The hybrid engine device includes a gas engine and an electrical engine. The electrical engine can comprise a fuel cell and/or a lithium battery. The fuel cell is preferably selected from the group comprising a proton exchange membrane fuel cell, a direct methanol fuel cell, an alkaline fuel cell, a phosphoric acid fuel cell, a molten carbonate fuel cell, and a solid oxide fuel cell. The lithium battery is preferably a secondary lithium battery, for e.g., a lithium ion battery or a lithium polymer battery. The gas engine and the electrical engine can be employed according to their respective characteristic advantages and the varying needs for propelling the vehicle 100. For example, the gas engine can be utilized for initiating motion of the vehicle 100, and the electrical engine can be used for providing uniform acceleration and uniform speed of the vehicle 100. Thereby, fuel is saved and pollution to the atmosphere caused by combustion of gas is decreased.

In summary, the networked vehicle system 102 has all the functions of the above-described systems 20, 30, 40, 50, 60, 70; namely, communication, identification recognition and theft protection, entertainment and other network-based functions, driver and passenger security, engine power control, air bag restraint, etc. Furthermore, the networked vehicle system 102 can effectuate centralized control of these systems through the IC 10.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A networked vehicle system comprising:
an information center comprising a host computer system configured for communicating with a wireless external network, and a signal emitting system configured for transmitting/broadcasting signals according to commands received from the host computer system;
a wireless communication system communicating with the host computer system and configured for effectuating data/information communication between the information center and the wireless external network;
a safety system comprising a plurality of image pick-up systems each configured for being mounted to a vehicle, the image pick-up systems each being connected to the host computer system and being configured for recording video images of inside and/or outside statuses of the vehicle;
an identification recognition and theft protection system comprising a signal amplifier comparator and a plurality of recognition sensors, the recognition sensors each being configured for transmitting recognition signals captured by the recognition sensors to the signal amplifier comparator, the signal amplifier comparator being connected to the host computer system, and being configured to compare the recognition signals with pre-stored data and transmit a comparison result to the host computer system; and
a multimedia entertainment system comprising a videoconference system, one or more video/audio input devices, and one or more video/audio output devices, each of the video/audio input and output devices being connected with the host computer system.

2. The networked vehicle system of claim 1, further comprising an automatic engine system, the automatic engine system comprising an engine control device and a power system, the engine control device being connected to the host computer system thereby accepting the control commands from the host computer system and sequentially feeding operating power parameters to the power system.

3. The networked vehicle system of claim 2, wherein the power system comprises a hybrid engine device.

4. The networked vehicle system of claim 3, wherein the hybrid engine device comprises a gas engine and an electrical engine.

5. The networked vehicle system of claim 4, wherein the electrical engine comprises at least one of a fuel cell and a lithium battery.

6. The networked vehicle system of claim 5, wherein the fuel cell is comprised of a battery selected from the group consisting of a proton exchange membrane fuel cell, a direct methanol fuel cell, an alkaline fuel cell, a phosphoric acid fuel cell, a molten carbonate fuel cell, and a solid oxide fuel cell.

7. The networked vehicle system of claim 5, wherein the lithium battery is a secondary lithium battery comprising at least one of a lithium ion battery and a lithium polymer battery.

8. The networked vehicle system of claim 1, wherein the wireless communication system comprises a hybrid positioning system, the hybrid positioning system comprising a blue tooth module, an ultra wideband module, and a global positioning system.

9. The networked vehicle system of claim 8, wherein the blue tooth module has a data broadcast speed in the range from about 700 Kbps to about 1000 Mbps.

10. The networked vehicle system of claim 8, wherein the ultra wideband module has a data broadcast speed in the range from about 100 Mbps to about 1000 Mbps.

11. The networked vehicle system of claim 1, wherein the multimedia entertainment system further comprises one or more high-definition television display devices each configured to be positioned inside the vehicle, and one or more high-definition acoustic devices each configured to be positioned inside the vehicle.

12. The networked vehicle system of claim 11, wherein each of the high-definition television devices is comprised of an item selected from the group consisting of a high-definition plasma display, a high-definition liquid crystal display, and a high-definition field emission display.

13. The networked vehicle system of claim 1, wherein the safety system further comprises an air bag restraint system having an air bag and a gas emitting inflator for emitting inflation gas into the air bag.

14. The networked vehicle system of claim 1, wherein the safety system further comprises a plurality of detectors each connected to the host computer system, the detectors being configured to be positioned at an outside of the vehicle and being configured for detecting distances between the vehicle and adjacent vehicles or objects.

15. The networked vehicle system of claim 1, wherein the image pick-up systems are configured to be mounted both inside and outside the vehicle, and the image pick-up systems mounted inside the vehicle are configured to be positioned spatially in correspondence with seats of the vehicle.

16. The networked vehicle system of claim 1, wherein the recognition sensors comprise any one or more items selected from the group consisting of a fingerprint sensor, an image sensor, and a voice sensor.

17. A vehicle comprising:
a vehicle body; and
a networked vehicle system mounted on the vehicle body, comprising:
an information center comprising a host computer system configured for communicating with a wireless external network, and a signal emitting system configured for transmitting/broadcasting signals according to commands received from the host computer system;
a wireless communication system communicating with the host computer system and configured for effectuating data/information communication between the information center and the wireless external network;
a safety system comprising a plurality of image pick-up systems each configured for being mounted to the vehicle, the image pick-up systems each being connected to the host computer system and being configured for recording video images of inside and/or outside statuses of the vehicle;
an identification recognition and theft protection system comprising a signal amplifier comparator and a plurality of recognition sensors, the recognition sensors each being configured for transmitting recognition signal captured by the recognition sensors to the signal amplifier comparator, the signal amplifier comparator being connected to the host computer system, and being configured to compare the recognition signals with pre-stored data and transmit a comparison result to the host computer system; and
a multimedia entertainment system comprising a videoconference system, one or more video/audio input devices, and one or more video/audio output devices, each of the video/audio input and output devices connected with the host computer system.

18. The vehicle of claim 17, further comprising an automatic engine system comprising an engine control device and a power system, the engine control device being connected to the host computer system thereby accepting the control commands from the host computer system and sequentially feeding operating power parameters to the power system.
